(19) United States
(12) Patent Application Publication
(10) Pub. No.: US 2018/0281207 A1
(43) Pub. Date: Oct. 4, 2018

(54) HOLDING MECHANISM, TRANSFER DEVICE, PICKING DEVICE, AND HANDLING ROBOT SYSTEM

(71) Applicant: Kabushiki Kaisha Toshiba, Minato-ku (JP)

(72) Inventor: Junya TANAKA, Ota (JP)

(73) Assignee: Kabushiki Kaisha Toshiba, Minato-ku (JP)

(21) Appl. No.: 15/889,675

(22) Filed: Feb. 6, 2018

(30) Foreign Application Priority Data
Apr. 4, 2017 (JP) 2017-074297

(51) Int. Cl. B25J 18/02; B25J 9/16; B25J 15/06

(52) U.S. Cl. CPC B25J 18/025; B25J 9/1697; Y10S 901/47; Y10S 901/09; Y10S 901/40; B25J 15/0625

(57) ABSTRACT

According to one embodiment, a holding mechanism includes a base part, a first drive part, a direction changing part, a stretching part, a holding part, a second drive part, and a tube. The first drive part is connected to an end of the base part. The direction changing part is connected to the first drive part and rotatable by driving of the first drive part. The stretching part is stretchable and connected to the direction changing part at an end of the stretching part. The holding part to hold an object is connected to the other end of the stretching part. The second drive part is able to be driven in a first direction. The tube is connected to the holding part and the second drive part, and movable in the first direction by driving of the second drive part.

### CROSS-REFERENCE TO RELATED APPLICATION

This application is based upon and claims the benefit of priority from Japanese Patent Application No. 2017-074297, filed on Apr. 4, 2017; the entire contents of which are incorporated herein by reference.

### FIELD

Embodiments described herein relate generally to a holding mechanism, a transfer device, a picking device, and a handling robot system.

### BACKGROUND

In recent years, a handling volume of objects (also referred to as luggage, workpiece etc.) is increasing due to expansion of mail order sales in the logistics industry. On the other hand, in Japan, there is concern about labor shortage due to low fertility and population aging, and needs for labor saving and automation in logistics centers or the like are rapidly rising. In the latest logistics centers, material handling equipment is utilized for automatic storage, loading/unloading, conveyance, sorting, and the like. In many cases, as a holding mechanism of the material handling equipment, the mechanism is adopted which is disposed at a tip of an articulated manipulator, and is configured to suck and hold an object using a suction pad or the like connected to a vacuum pump. The work of picking objects from a shelf or the like is required to hold and convey various types of objects at a high speed. Therefore, suction by suction pads is suitable for holding objects.

However, when the holding mechanism has to access and hold the object in a lateral direction of the shelf, the object to be held may be located behind another object. In this case, it is necessary to hold the object to be held after holding another object first and changing its position, and the operation tact of picking increases. In addition, when the shelf is small and there is no place to change the position of another object, it is difficult to pick only the object to be held. Therefore, there are still a lot of works relying on humans. There is a need for development of a holding mechanism capable of efficiently picking objects placed in a narrow space such as a shelf.

### BRIEF DESCRIPTION OF THE DRAWINGS

FIG. 1 is a schematic view showing an example of a handling robot system using a holding mechanism according to the first embodiment.

FIGS. 2A and 2B are perspective views showing an example of a holding mechanism according to the first embodiment.

FIGS. 3A and 3B are perspective views showing an example of the holding mechanism in a case where the direction changing part is rotated such that the holding part is directed in the −Z direction.

FIG. 4 is a block diagram showing relationship between the configuration of the control device and various types of sensors and the transfer device.

FIG. 5 is a flowchart showing an example of operation of the handling robot system.

FIGS. 6A-6F are schematic views showing an example of a holding procedure for holding an object placed inside a shelf.

FIG. 7 is a flowchart showing an example of processing for transferring an object in a handling robot system according to the first embodiment.

FIG. 8 is a flowchart showing an example of processing of step 701 of FIG. 7.

FIG. 9 is a flowchart showing an example of processing of step 702 of FIG. 7.

FIG. 10 is a flowchart showing an example of processing of step 703 of FIG. 7.

FIG. 11 is a diagram showing an example of a holding mechanism according to the second embodiment.

FIGS. 12A and 12B are schematic views showing an example of a holding mechanism according to the third embodiment.

FIG. 13 is a diagram showing an example of a holding mechanism according to the fourth embodiment.

FIG. 14 is a diagram showing an example of a holding mechanism according to the fifth embodiment.

FIG. 15 is a diagram showing an example of a holding mechanism according to the sixth embodiment.

### DETAILED DESCRIPTION

According to one embodiment, a holding mechanism includes a base part, a first drive part, a direction changing part, a stretching part, a holding part, a second drive part, and a tube. The first drive part is connected to an end of the base part. The direction changing part is connected to the first drive part and rotatable by driving of the first drive part. The stretching part is stretchable and connected to the direction changing part at an end of the stretching part. The holding part to hold an object is connected to the other end of the stretching part. The second drive part is able to be driven in a first direction. The tube is connected to the holding part and the second drive part, and movable in the first direction by driving of the second drive part.

Hereinafter, a holding mechanism and a handling robot system according to embodiments will be described with reference to the drawings. Those with the same reference numerals indicate the same elements. It should be noted that the drawings are schematic or conceptual, and the relationship between the thickness and the width of each portion, the ratio coefficient of the size between the portions, and the like are not necessarily the same as the actual ones. Also, even in a case of representing the same portions, the dimensions and ratio coefficients may be different from each other depending on the drawing.

### First Embodiment

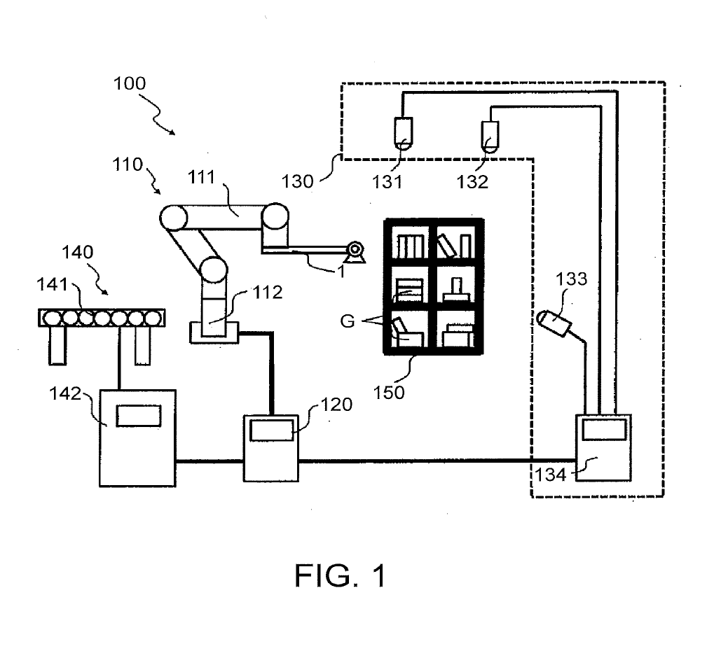

The first embodiment will be described below with reference to FIG. 1. FIG. 1 is a schematic view showing an example of a handling robot system using a holding mechanism 1 according to the first embodiment.

As shown in FIG. 1, the handling robot system 100 includes a transfer device 110, a control device 120, a recognition device 130, and a conveyance device 140.

The handling robot system 100 recognizes a plurality of objects G placed on a placing area 150 by the recognition device 130 and a recognition part of the holding mechanism 1 which will be described below. Then, using a result of the recognition, the control device 120 holds the objects G by driving the transfer device 110, and transfers the objects G to the conveyance device 140. Also, the objects G positioned on the conveyance device 140 are held by the transfer device 110, and the objects G are placed on the placing area 150. The objects G include a product contained in cardboard boxes, a packaged product, and a product itself.

First, the transfer device 110 will be described. As shown in FIG. 1, the transfer device 110 includes a manipulator 111, a base part 112 configured to fix the manipulator 111, and a holding mechanism 1 configured to hold an object G arranged at the tip of the manipulator 111.

The manipulator 111 includes at least two links and a plurality of joint parts respectively connecting the ends of the links. The joint part is configured by, for example, a motor, an encoder, a reduction gear, and the like. The manipulator 111 enables each link to be rotated or linearly moved by driving the motor. Therefore, the holding mechanism 1 arranged at the tip is moved. The joint part is not limited to rotation in one axial direction but includes rotation in multiple axial directions. The manipulator 111 is a so-called vertical articulated type robot. Further, the manipulator 111 may be configured by a combination of a linear moving mechanism in the directions of the three axes (XYZ axes), a rotation axis that rotates the link, and a joint part.

The base part 112 fixes an end of the manipulator 111. The base part 112 is installed on the floor surface or on the ground. The base part 112 may be, for example, a movable truck, and the transfer device 110 may be movable on the floor surface.

The holding mechanism 1 has a holding part capable of holding an object G. The holding part is installed in a stretching part that is stretchable, and the holding part is movable in the direction of the object G by stretching the stretching part. The stretching part is stretched depending on a position of the object G, and the holding part is moved to a position of the object G and holds the object G.

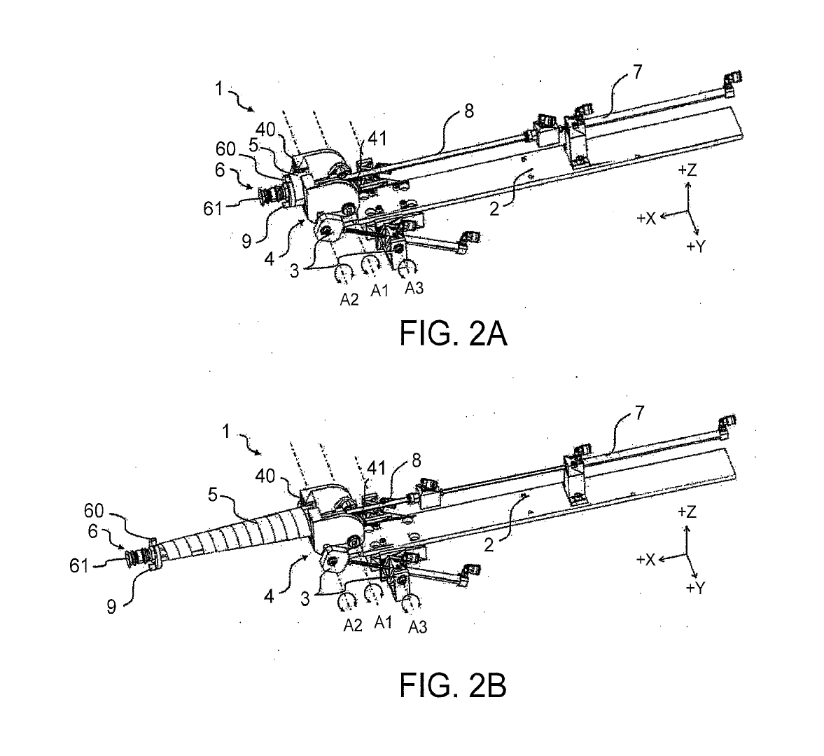

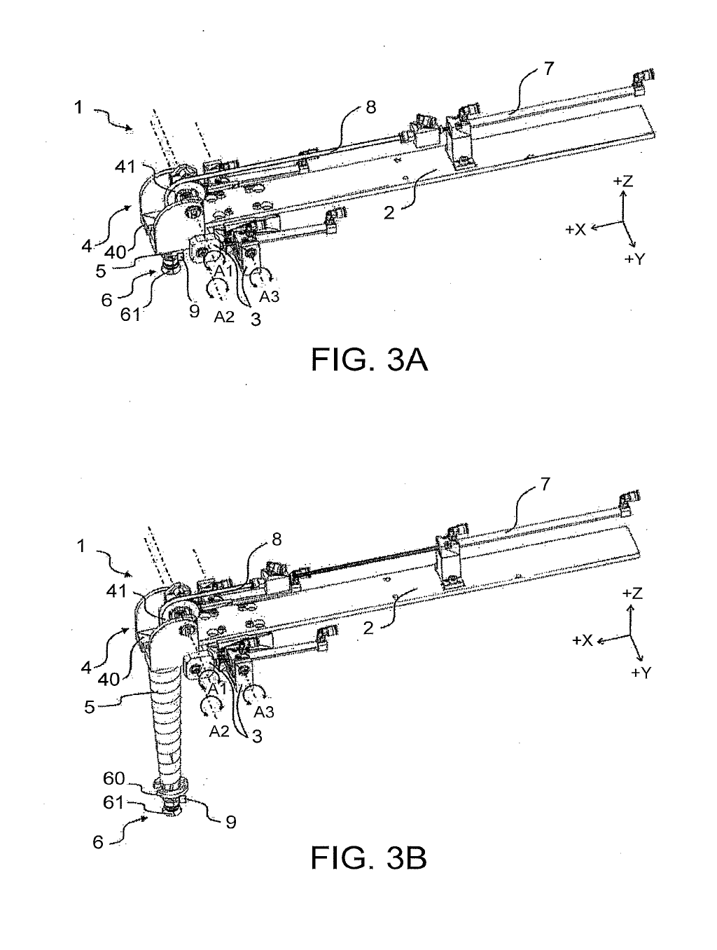

Next, a configuration of the holding mechanism according to the present embodiment will be described below in detail with reference to FIGS. 2A, 2B and 3.

FIGS. 2A and 2B are schematic views showing an example of the holding mechanism 1 according to the present embodiment. FIG. 2A shows a contracted state of the holding mechanism 1. FIG. 2B shows an extended state of the holding mechanism 1.

The “contracted state” of the holding mechanism represents a state in which the stretching part is contracted. In this case, the holding part 6 is positioned at the nearest distance from the direction changing part 4. Also, the “extended state” of the holding mechanism 1 represents a state in which the stretching part is extended. In this case, the holding part 6 is positioned at the farthest distance from the direction changing part 4. The state in which the holding mechanism 1 is contracted is referred to as an initial state.

Here, for the convenience of description, definition is made for +X direction, −X direction, +Y direction, −Y direction, +Z direction, and −Z direction. +X direction, −X direction, +Y direction, and −Y direction are directions along, for example, a substantially horizontal surface. −X direction is a direction opposite to +X direction. In embodiments, +X direction and −X direction are “directions in which the second drive part (linear drive part) performs driving”. +Y direction is a direction intersecting with +X direction (for example, substantially orthogonal direction). −Y direction is a direction opposite to +Y direction. +Z direction is a direction intersecting with +X direction and +Y direction (for example, substantially orthogonal direction), for example, substantially vertically upward direction. −Z direction is a direction opposite to +Z direction, for example, a substantially vertically downward direction.

As shown in FIGS. 2A and 2B, the holding mechanism 1 includes a base part 2, a first drive part 3, a direction changing part 4, a stretching part 5, a holding part 6, a second drive part 7, a tube 8, and a recognition part 9.

The base part 2 is a part in which the first drive part 3 and the second drive part 7 are installed and is arranged along an X axial direction (also referred to as a first direction). The base part 2 is formed of a thin metal plate. Since the base part 2 supports other configurations of the holding mechanism 1, the base part 2 is preferably formed of a member having higher rigidity. A base end of the base part 2 is connected to a tip of the manipulator 111.

The direction changing part 4 is positioned at a tip of the base part 2. The direction changing part 4 is rotatable around a rotary shaft A1. Also, the first drive part 3 is installed at the tip of the base part 2. The direction changing part 4 is connected to the first drive part 3 and is rotated around the rotary shaft A1 by driving of the first drive part 3. The first drive part 3 is a linear moving mechanism. The first drive part 3 includes, for example, a transverse feed ball screw and a stepping motor, and is driven by the stepping motor. The first drive part 3 may be implemented by any device as long as the device is capable of generating a driving force for rotating the direction changing part 4. For example, it may be a pneumatic drive motor, a pneumatic cylinder, or a combination of speed reduction mechanisms. The first drive part 3 further includes rotary shafts A2 and A3, and is rotatable around each of the rotary shafts. The rotary shafts A1 to A3 are in a direction substantially parallel to a Y-axial direction. The driving force of the first drive part 3 in the direction of linear movement is transferred to the direction changing part 4 via the rotary shaft A2. The rotary shaft A2 converts the driving force of the first drive part 3 in the direction of the linear movement into a rotary driving force of the direction changing part 4 around the rotary shaft A1. The first drive part 3 is rotated around the rotary shaft A3 according to the rotation of the direction changing part 4. Specifically, a distance from the rotary shaft A1 to the rotary shaft A3 and a distance from the rotary shaft A1 to the rotary shaft A2 are constant. On the other hand, a distance from the rotary shaft A2 to the rotary shaft A3 is variable by driving of the first drive part 3 in the direction of the linear movement. A rotation angle of the direction changing part 4 is determined based on an angle between a line segment connecting the rotary shafts A1 and A2 and a line segment connecting the rotary shafts A1 and A3. A sensor that measures a rotation angle around the rotary shaft A1 may be installed.

Although the first drive part 3 has been described as being a linear moving mechanism, the first drive part 3 may be a mechanism which includes a rotary shaft A1, a motor installed on the rotary shaft (not shown), a reduction gear (not shown) and an encoder (not shown), and is rotatable around the rotary shaft A1. The encoder measures a rotation angle of the motor (rotational displacement quantity of the motor), the number of rotations, a speed of the motor, a load of the motor, and the like. The encoder is arranged so as to measure a driving state of the motor. For example, embodiments are not limited to the encoder, and a displacement sensor, an ultrasonic sensor, a variable resistor, a capacitance sensor, a pulse coder, a fiber sensor, a laser displacement sensor, or the like may be used as long as the drive state of the motor can be known. Further, another sensor that outputs a voltage or a current according to the distance may be used. Information measured by these sensors is transmitted to the control device 120. The reduction gear decelerates the rotation speed of the motor and determines the rotation speed of the direction changing part 4. The reduction ratio is appropriately adjusted according to the number of rotations of the motor and the like. When the rotation speed is adjusted on the motor side, the reduction gear is not an essential configuration.

The direction changing part 4 includes a mounting part 40 configured to mount the stretching part 5 and a rotary roller 41 configured to change a bending direction of the tube 8. As shown in FIGS. 2A and 2B, the mounting part 40 at an initial position at which the first drive part 3 is not rotated is installed such that the stretching part 5 is directed in +X direction. The rotary roller 41 has a rotary shaft and is rotatable around the rotary shaft. The rotary shaft is substantially parallel to the rotary shaft A1. The number of the rotary rollers 41 is not limited to one and may be plural. For example, when the number of the rotary rollers 41 is two, the tube 8 may be held between the two rotary rollers 41 and be bent in the rotation direction of the direction changing part 4. Since the tube 8 is inserted from the X direction in the direction changing part 4, a space through which the tube 8 passes is provided in the mounting part 40.

The stretching part 5 has a so-called paper rolling shape (also called a wound body) in which a thin metal plate is wound around a predetermined shaft. The predetermined shaft is substantially parallel to the direction in which the tube 8 passes through the direction changing part 4. The plate has been wound in a direction substantially perpendicular to the shaft from the vicinity of the shaft. As the number of turns increases, a winding radius gradually increases. The winding start part of the wound body is called a winding start portion, and the winding end part of the wound body is called the winding end portion. Since the wound body has a paper rolling shape, the wound body is in a contracted state normally. When the wound body is in an extended state, an elastic force occurs in a direction opposite to the direction of extension. That is, the elastic force occurs such that the wound body is in the contracted state. As described below, in order to keep the wound body in an extended state, a force equal to the elastic force is applied to the stretching part. When the direction changing part 4 is not rotated as shown in FIGS. 2A and 2B, the wound body is stretchable in the X direction. When the direction changing part 4 is rotated by the first drive part 3, the stretching direction of the wound body is changed depending on the rotation angle of the direction changing part 4. The wound body is connected to the mounting part 40 of the direction changing part 4. Specifically, the winding end portion of the wound body is connected to the mounting part 40. Further, the winding start portion is connected to the holding part 6. As shown in FIG. 2B, the wound body is in a state in which the plate wound in the extended state is shifted in a spiral shape. In other words, the wound body has a reduced diameter toward a tip to which the holding part 6 is connected in the extended state. The stretching part 5 is not limited to the shape of the wound body as described above. For example, it may be configured by a multi-stage linear guide structure, a multi-stage cylinder structure, a bellows structure, or the like. Further, the arrangement of the wound body may be reversed. The winding start portion of the wound body may be connected to the mounting part 40, and the winding end portion of the wound body may be connected to the holding part.

The holding part 6 includes a connection part 60 and a suction pad 61. The holding part 6 is a part for holding the object G. The holding part 6 is connected to a vacuum pump via a tube 8, for example, and holds the object G by reducing a pressure between the suction pad 61 and the object G by the vacuum pump. The suction pad 61 is installed in the connection part 60. The connection part is connected to the winding start portion of the stretching part 5. Further, the tube 8 is connected to the connection part 60. The holding part 6 may approach and come in contact with the object G by extension of the stretching part 5. The number of the suction pads 61 is not limited to one and may be one or more. The number of the suction pads 61 may be appropriately changed depending on the size and shape of the object G to be held. Determination of whether or not the holding part 6 has succeeded in holding the object G may be performed based on, for example, a measured value of a pressure sensor or a flow rate sensor connected via the tube 8, or based on a deformation amount of the suction pad 61 measured from image data. When the determination is performed based on the image data, a result of recognition by the recognition part 9 to be described below may be used. Alternatively, a contact sensor or a proximity sensor may be provided in the suction pad 61, and the determination may be performed based on a change in sensor output. The information measured by these sensors is transmitted to a control device 120 which will be described below.

The second drive part 7 is arranged side by side with the base part 2, and a part thereof is connected to the base part 2. That is, the second drive part 7 is disposed along the X direction and can be driven in the X direction. The second drive part 7 is a linear moving mechanism. For example, the second drive part 7 has a transverse feed ball screw and a stepping motor, and may operate in the X direction by driving the stepping motor. It may also be driven by a linear actuator or a pneumatic cylinder. The second drive part 7 may have a displacement sensor capable of measuring a drive amount. As the displacement sensor, for example, an encoder, an ultrasonic sensor, a variable resistor, a capacitance sensor, a pulse coder, a fiber sensor, or a laser displacement sensor is used. Also, other sensors that output voltage or current depending on a distance may be used. A sensor for detecting that a movable part of the second drive part 7 has reached either of both ends, for example, a switch-type sensor, or an auto switch (which is a sensor for detecting a position of a cylinder) may be used. The information measured by these sensors is transmitted to the control device 120, which will be described below.

The tube 8 connects the holding part 6 and the second drive part 7 as shown in FIGS. 2A and 2B. The tube 8 is formed of a hollow elastic body, and is capable of circulating a fluid, such as air, in the inside thereof. The tube 8 is arranged substantially in parallel with the X direction and is movable in the X direction by driving of the second drive part 7. The holding part 6 is moved according to the movement of the tube 8, and the stretching part 5 is stretched. That is, when the driving force for moving the tube 8 is larger than an elastic force of the stretching part 5, the stretching part 5 is extended. In addition, the tube 8 is bent along a rotary roller 41 by the rotation of the direction changing part 4. The tube 8 is preferably formed of a material that is rigid in an axial direction and is flexible in a bending direction so as to push out the holding part 6 and the stretching part 5 in the X direction. In addition, since an outer shell of the stretching part 5 is formed of a metal plate and, therefore, is highly rigid, the stretching part 5 prevents the tube 8 from buckling in an extended state.

As described above, the tube 8 is connected to a vacuum pump (not shown) to reduce the pressure between the suction pad 61 and the object G. For example, a nozzle may be provided in a part of the tube 8 or the second drive part 7, and the tube 8 may be connected to the vacuum pump through the nozzle. In addition to the vacuum pump, a negative pressure generating device may be constructed by combining a pressurizer and a vacuum generator to generate negative pressure. In addition, a switching valve may be installed in the middle of piping between the suction pad 61 and the vacuum pump to arbitrarily control the start and stop of suction. The switching valve may be a valve of a type driven by a solenoid valve or an electric motor, or a valve of a type driven by an air pressure. In addition, a pressure generating device such as a compressor may be arranged in the switching valve. In the configuration in which the suction pad 61 and the switching valve are arranged and the negative pressure generating device and the pressure generating device are arranged in the switching valve, it is possible to switch between the negative pressure state and the positive pressure state of the suction pad at an arbitrary timing by controlling the switching valve. Therefore, it is possible to smoothly perform suction and release of the suction pad. When there are a plurality of suction pads, a control valve that switches between On and Off may be installed in each of the suction pads.

The recognition part 9 is installed in a connection part 60 of the holding part 6 and recognizes arrangement or the like of an object G in the shelf, for example. The recognition part 9 may utilize a three-dimensional position-measurable camera such as a distance image sensor or an infrared dot pattern projection camera. The infrared dot pattern projection camera projects an infrared dot pattern onto a target object and then captures an infrared image of the target object in that state. It is possible to obtain three-dimensional information of the target object by analyzing the infrared image. The infrared dot pattern projection camera may capture a color image or a monochrome image. Alternatively, in addition to the infrared dot pattern projection camera, the recognition part 9 may further include an optical sensor such as a camera that acquires a color image or a monochrome image. In addition, the recognition part 9 may have a plurality of cameras. A recognition result by the recognition part 9 is transmitted to the control device 120, and the control device 120 derives the shape, distance, object information, and the like of the object G. The recognition result may be image data containing distance information. The image data may be, for example, commonly used image data such as jpg, gif, png, or bmp.

Next, an example of operation of the holding mechanism 1 will be described. Here, a description will be given for a case where an object G to be held is located immediately below the holding mechanism 1 (−Z direction).

First, the holding mechanism 1 drives the first drive part 3 and rotates the direction changing part 4 such that the suction pad 61 is directed in a direction in which the object G is positioned. Due to the rotation of the direction changing part 4, the tube 8 is bent in the direction in which the object G is positioned.

The second drive part 7 is driven to move the tube 8 in the +X direction. At this time, since the direction of movement of the tube 8 is changed in the direction in which the object G is positioned (in a vertically downward direction) by the rotary roller 41 of the direction changing part 4, the tube 8 is moved in the direction in which the object G is positioned. The stretching part 5 extends and the suction pad 61 of the holding part 6 comes into contact with the object G according to the movement of the tube 8.

Thereafter, the inside of the suction pad 61 is depressurized by the vacuum pump, and the suction pad 61 sucks to the object G. In a state in which the holding part 6 holds the object G, the second drive part 7 moves the tube 8 in the −X direction, and the holding mechanism is in a contracted state.

FIGS. 3A and 3B are perspective views showing an example of the holding mechanism 1 in a case where the direction changing part 4 is rotated such that the holding part is directed in the −Z direction. FIG. 3A is a perspective view showing a state in which the stretching part is contracted. FIG. 3B is a perspective view showing a state in which the stretching part is extended.

As described above, in a case where the object G is positioned immediately below the holding mechanism 1, the holding mechanism 1 holds the object G in the posture shown in FIGS. 3A and 3B. In a case of suction holding, the upper surface of the object G is basically held but the rotation angle of the direction changing part 4 may be appropriately changed depending on a placed state of the object G. The timing for extending the stretching part 5 may not be after the direction changing part 4 has been rotated. The direction changing part 4 may be rotated while extending the stretching part 5.

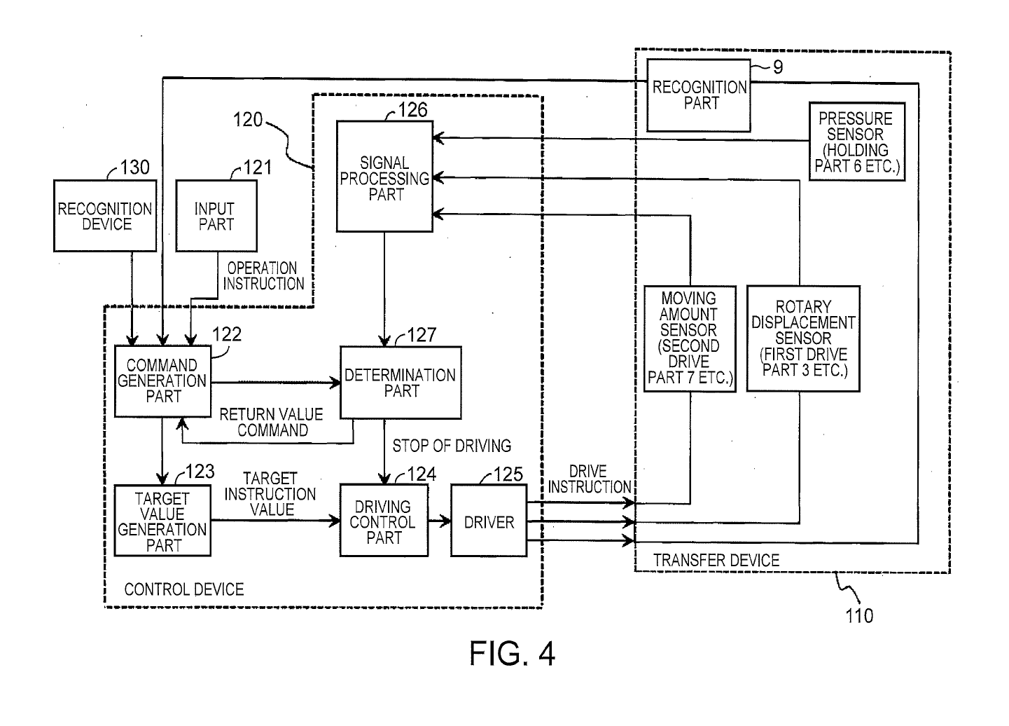

Next, the control device 120 will be described. FIG. 4 is a block diagram showing relationship between the configuration of the control device 120 and various types of sensors and the transfer device 110. The frame (left side) of the broken line in FIG. 4 represents the configuration of the control device 120.

The control device 120 includes an input part 121, a command generation part 122, a target value generation part 123 configured to generate a target instruction value, a drive control part 124, a driver 125, a signal processing part 126, and a determination part 127.

The input part 121 is a place into which the operation instruction information of the transfer device 110 is input. The input to the input part 121 may be direct input, for example, via a touch panel or a monitor, or may be input from a remote place in a radio manner or a wired manner. When radio communication is performed, the input part 121 functions as a communication part. The communication part receives operation instruction information from an external computer or a server. Although a radio communication device is preferable, the communication device may be configured as a communication network. As the communication network, for example, internet, intranet, extranet, LAN, ISDN, VAN, CATV communication network, virtual private network, telephone line, mobile communication network, satellite communication network and the like may be used. The transmission medium configuring the communication network is not particularly limited, and wired medium such as IEEE 1394, USB, power line carrier, cable TV line, telephone line, ADSL line, and wireless medium such as infrared line such as IrDA and remote controller, Bluetooth®, 802.11 wireless, HDR, portable telephone network, satellite line, terrestrial digital network and the like may be used. The input part 121 transmits the operation instruction information to the command generation part 122. Alternatively, a microphone is installed in the input part 121, and the operation instruction information may be input by the operator's (user's) voice. The input part 121 is not necessarily a required component in a case where the handling robot system automatically recognizes the object G and performs driving operation.

The command generation part 122 generates, as an operation command, operation procedures required for each operation process, based on the operation instruction information, the result of recognition by the recognition part 9 installed in the holding mechanism 1, and the result of recognition of the object G in the recognition device 130, which will be described below. The command generation part 122 generates pieces of operation mode information respectively corresponding to operation commands to be executed. The operation commands are commands related with a series of operations of the transfer device 110, for example, information as a program. The operating mode information is information related with an individual operation. For example, there are operations to “lift” or “lower” the holding mechanism 1. The command generation part 122 has a storage that stores operation mode information and the like. The storage also stores attribute data such as a shape, a weight, or flexibility of an object that is a target to be held, in advance. Examples of the storage includes a tape system such as a magnetic tape or a cassette tape, a disk system including a magnetic disk, for example, a Floppy® disk, a hard disk or the like or an optical disk, for example, a CD-ROM/MO/MD/DVD/CD-R or the like, a card system such as an IC card (including a memory card)/an optical card or the like, or a semiconductor memory such as a mask ROM, an EPROM, an EEPROM, a flash ROM or the like. The command generation part 122 outputs the operation command to the target value generation part 123. The command generation part 122 associates each operation mode of the operation command with practical operation information stored in the storage, and outputs them to the determination part 127.

The target value generation part 123 receives the operation command for the manipulator 111 and the holding mechanism 1 from the command generation part 122. The target value generation part 123 generates target instruction values for the manipulator 111 and the holding mechanism 1. The target instruction value is output to the drive control part 124.

The drive control part 124 receives the target instruction value for the manipulator 111 and the holding mechanism 1 from the target value generation part 123, and generates the drive instruction information for driving the manipulator 111 and the holding mechanism 1 according to the target instruction value. The drive instruction information is output to the driver 125.

The driver 125 receives the drive instruction information for the manipulator 111 and the holding mechanism 1 from the drive control part 124, and generates a drive instruction. The manipulator 111 and the holding mechanism 1 receive the drive instruction from the driver 125, and adjusts a drive amount by operating an actuator and the like. As the actuator, for example, a combination of a motor and a feed screw, or a pneumatic cylinder can be used.

The signal processing part 126 receives signals of various sensors (the sensor attached to the first drive part 3, the second drive part 7, the direction changing part 4 and the holding part 6) by the driving of the manipulator 111 and the holding mechanism 1, and performs signal amplification processing and analog-digital conversion processing for the sensor signals.

The determination part 127 receives the sensor signal obtained by conversion by the signal processing part 126. The determination part 127 determines adjustment of a drive amount of the holding mechanism 1, existence or nonexistence of slope in placing environment, the posture of an object, a holding state of the object, and the like, according to the sensor signals. The determination part 127 receives the operation information of the manipulator 111 and the holding mechanism 1 corresponding to the operation command from the command generation part 122. The determination part 127 compares the operation information with information based on the sensor signals. Based on a result of the comparison, the determination part 127 generates an operation command, such as an operation command for stopping the drive of the manipulator 111 and the holding mechanism 1 or an operation command for correcting the posture of the manipulator 111 according to an object state. The determination part 127 outputs a return value command for correcting the operation command to the command generation part 122. Due to the return value command, the command generation part 122 can correct the operation command and perform an appropriate processing operation for the operation instruction information input by the input part. Therefore, assurance and reliability of the operation of the holding mechanism 1 are improved.

The command generation part 122, the target value generation part 123, the drive control part 124, the signal processing part 126, and the determination part 127 include a central processing unit (CPU), a memory, an auxiliary storage or the like, and execute a program or the like. Further, all or some thereof may be realized using hardware such as application specific integrated circuit (ASIC), programmable logic device (PLD) or field programmable gate array (FPGA).

Next, the recognition device 130 will be described. As shown in FIG. 1, the recognition device 130 recognizes a plurality of objects G placed in the placing area 150.

The recognition device 130 includes a first image sensor 131 to a third image sensor 133, and a calculator 134 connected to each of the image sensors.

The first image sensor 131 to the third image sensor 133 are positioned in an oblique front surface, an upper surface, and an oblique rear surface with respect to the plurality of objects G placed on the placing area 150, for example. The first image sensor 131 to the third image sensor 133 may be movable. The first image sensor 131 to the third image sensor 133 may use a three-dimensional camera capable of measuring positions, such as a distance image sensor or an infrared dot pattern projection camera. The infrared dot pattern projection camera projects an infrared dot pattern onto a target object and then captures an infrared image of the object G placed on the placing area 150 in that state. It is possible to obtain the three-dimensional information of the object G by analyzing the infrared image. The infrared dot pattern projection camera may capture a color image or a monochrome image. In addition to the infrared dot pattern projection camera, an optical sensor such as a camera that acquires a color image or a monochrome image may be included. The image may be commonly used image data such as jpg, gif, png, or bmp. Although three image sensors have been described, the number of image sensors is not limited thereto, and may be more than one. In addition, three or more image sensors may be used.

The calculator 134 derives the position information of the object G, based on data output from the first image sensor 131 to the third image sensor 133. The three-dimensional position information of the object G is output to the control device 120. The control device 120 controls the transfer device 110 based on the position information of the object G. The calculator 134 includes, for example, a CPU, a memory, an auxiliary storage and the like, and executes a program or the like. However, all or some thereof may be realized using hardware such as ASIC, PLD, or FPGA. Also, the calculator 134 may be included in the control device 120.

Next, the conveyance device 140 will be described. As shown in FIG. 1, the conveyance device 140 is a place where the object G held by the transfer device 110 is placed and conveyed.

The conveyance device 140 includes a belt conveyor 141 in which, for example, a plurality of rollers are arranged in a predetermined direction and a belt is wound, and a conveyance control device 142. The belt conveyor 141 drives the belt by rotating the plurality of rollers in the predetermined direction to convey the objects G. The conveyance control device 142 controls the driving of the belt conveyor. For example, the conveyance speed and the conveyance direction are controlled. The conveyance device 140 is connected to the control device 120.

The conveyance device 140 is not limited to a belt conveyor, and includes a roll conveyor, another sorting device, or the like. The conveyance control device 142 is, for example, a computer including a CPU, a memory, or an auxiliary storage. The operation of the conveyance device 140 is automatically controlled by the conveyance control device 142 through a pre-set program set, but may be also controlled in such a way that the operator manually manipulates the conveyance control device 142. The conveyance control device 142 may be included in the control device 120.

The placing area 150 is a place where the object G is stacked or placed. The placing area 150 may be a shelf, a cage truck, a steer truck, a box palette, a pallet, or the like. The placing area may be movable.

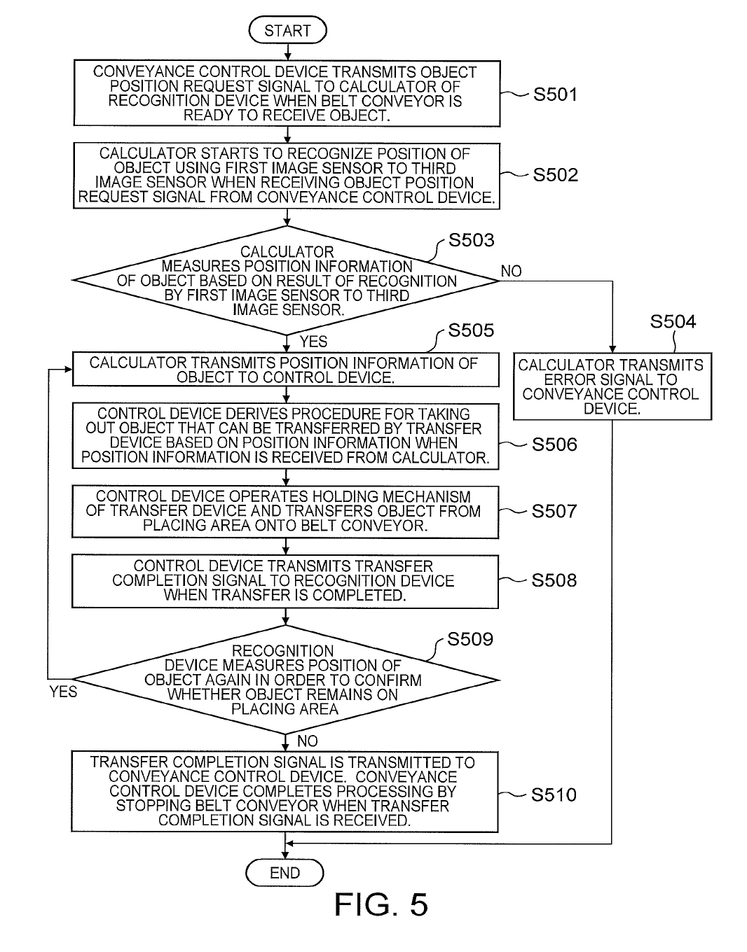

Next, an example of operation of the handling robot system according to the present embodiment will be described. FIG. 5 is a flowchart of an example of an example of operation of the handling robot system.

First, the conveyance control device 142 of the conveyance device 140 transmits an object position request signal to the calculator 134 of the recognition device 130 when the belt conveyor 141 is ready to receive the object G (step 501). When the calculator 134 receives the object position request signal from the conveyance control device 142, the calculator 134 starts to recognize the position of the object G using the first image sensor 131 to the third image sensor 133 (step 502). The calculator 134 measures position information of the object G, based on a result of recognition by the first image sensor 131 to the third image sensor 133 (step 503). If no object G is detected (the case of No), the calculator 134 transmits an error signal to the conveyance control device 142 (step 504). When the object G is detected (the case of Yes), the calculator 134 transmits the position information of the object G to the control device 120 (step 505).

When the control device 120 receives the position information from the calculator 134, the control device 120 derives a procedure for taking out the object G that can be transferred by the transfer device 110, based on the position information (step 506). The control device 120 operates the holding mechanism 1 of the transfer device 110 to transfer the object G from the placing area 150 onto the belt conveyor 141 (step 507). When the transfer is completed, the control device 120 transmits a transfer completion signal to the recognition device 130 (step 508). The recognition device 130 again performs position measurement of the object G in order to confirm whether an object G remains on the placing area 150 (step 509). When the object G remains (the case of Yes), the calculator 134 transmits the position information to the control device 120, and the object G is transferred (return to step 505). When the object G does not remain (the case of No), the transfer completion signal is transmitted to the conveyance control device 142. When the conveyance control device 142 receives the transfer completion signal, the conveyance control device 142 stops the belt conveyor 141 to complete processing (step 510). In addition, when the conveyance control device 142 receives the transfer completion signal, the conveyance control device 142 may issue a warning or the like for informing the operator of it. The operator who has heard the warning may replace the placing area (for example, shelf, etc.) where the object G is absent, with another placing area (for example, shelf, etc.) where the object G is placed. In the handling robot system of the present embodiment, it is preferable that the plurality of objects G placed in the placing area 150 of the shelf are transferred sequentially from an object G in the front of the shelf, which is easy to be held by the holding mechanism 1. The work of replacing a shelf or the like on which the object G is absent with another shelf on which the object G is placed may be automated by using an automatic converter which conveys shelves and the like. When the placing area 150 is a cardboard box or the like, it is preferable that the plurality of objects G placed are sequentially transferred from the uppermost object G which is easy to be held by the holding mechanism 1.

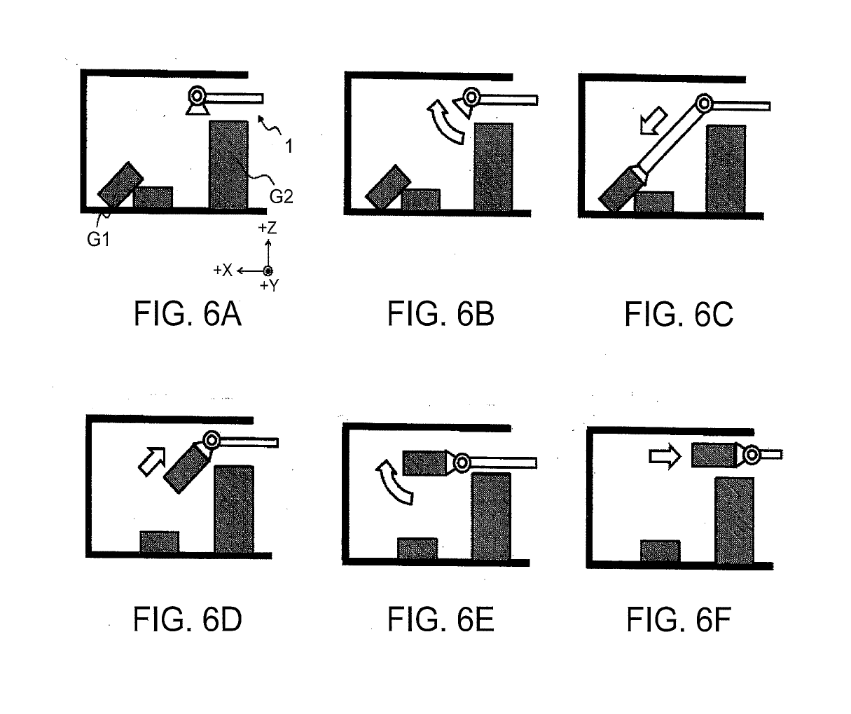

Next, a holding procedure for holding the object by the holding mechanism 1 in the handling robot system will be described. FIGS. 6A-6F are schematic views showing an example of a holding procedure for holding an object placed on the inside of a shelf. FIGS. 6A-6F are cross-sectional views of the inside of the shelf when seen from the lateral direction.

As shown in FIG. 6A, an object G1 is placed behind a large object G2. When the object G1 is a target object to be held, the control device 120 acquires position information of the objects G1 and G2 using the recognition device 130 or the recognition part 9 of the holding mechanism 1, and determines whether the object G1 can be held. When the control device 120 determines that the object G1 can be held, the control device 120 controls the transfer device 110 to perform an operation of holding the object G1. When the target object G1 to be held is at a position that cannot be recognized by the recognition device 130, the control device 120 may allow the holding mechanism 1 to enter the shelf from the upper surface of the object G2 in advance, and allow the recognition part 9 to recognize the state of the inside of the shelf.

The control device 120 allows the holding mechanism 1 to enter the inside of the shelf from the upper surface of the object G2 by driving the manipulator 111 based on the result of recognition by the recognition part 9. At this time, the holding mechanism 1 is in a contracted state. When position and posture information of the object G2 is accurately derived based on the result of recognition by the recognition part 9, the control device 120 stops the entering operation before the holding mechanism 1 contacts the upper surface of the object G2. When the position information of the object G2 is not accurately derived based on the result of recognition, the control device 120 may detect the contact in such a way that, for example, a contact sensor disposed on a surface of the base part of the holding mechanism 1 contacts the upper surface of the object G2. In addition, the contact between the base part of the holding mechanism 1 and the object G2 may be monitored by the recognition device 130. In this way, the control device 120 allows the holding mechanism 1 to enter the inside of the shelf while avoiding the holding mechanism 1 from contacting the object G2.

Next, as shown in FIG. 6B, the control device 120 rotates the direction changing part 4 of the holding mechanism 1 to direct the stretching part 5 and the holding part 6 in a direction in which the object G1 is disposed. At this time, the control device 120 may determine a rotation angle of the direction changing part 4, based on the position and posture information of the object G1 by the recognition part 9.

Next, as shown in FIG. 6C, the stretching part 5 is stretched. When the position and posture information of the object G1 is accurately derived based on the result of recognition, the control device 120 stops the extending operation at the same time when the holding part 6 contacts a holding surface of the object G1. When the position and posture information of the object G1 is not accurately derived based on the result of recognition, it may be possible that the holding part 6 contacts the object G1 and the contact is detected by a contact sensor. In addition, the sensing of the contact state with the object may be replaced with the use of a pressure value of the pressure sensor or the flow sensor of the suction pad 61. Thus, it is possible to detect that the holding part 6 is in contact with the object G1 and immediately stop the extending operation of the stretching part 5. Also, the operation of FIGS. 6B and 6C may be repeatedly performed. At this time, the stretching part 5 of the holding mechanism 1 is extended to bring the holding part 6 into contact with the object G1. The contact is detected by the contact sensor or the proximity sensor installed in the holding part 6, and an output value of the contact sensor is compared with a predetermined threshold value. When the output value is equal to or less than the threshold value, the stretching part 5 is contracted. Furthermore, an angle of the direction changing part 4 is changed and the stretching part 5 is extended again to bring the holding part 6 into contact with the object G1. A series of operations may be performed repeatedly until the output value of the contact sensor becomes equal to or greater than the threshold value, and the optimum position and posture for holding the object G1 may be searched.

Next, as shown in FIG. 6D, the control device 120 contracts the stretching part 5 under the state that the holding part 6 holds the object G1. At this time, the control device 120 may determine the contraction amount of the stretching part 5 based on the position and posture of the object G1. When an actuator of the second drive part 7 that performs the stretching operation of the stretching part 5 is electrically driven, overload current acting by inertia force may be detected and the contracting operation may be stopped. In addition, the contraction amount of the stretching part 5 may be determined based on the result of recognition by the recognition part 9 or the like.

Next, as shown in FIG. 6E, the control device 120 allows the holding mechanism 1 to pull the object G1 out of the shelf under the state that the holding mechanism 1 holds the object G1. The direction changing part 4 of the holding mechanism 1 is rotated to a position at the time of entry (in the horizontal direction with respect to the base part), and the posture of the direction changing part 4 is changed such that the object G1 does not come into contact with the object G2. At this time, the angle of the direction changing part 4 that allows the object G1 not to contact the object G2 may be determined based on the position and posture information of the object G2 recognized in advance.

As shown in FIG. 6F, the control device 120 drives the manipulator 111 to pull out the object G1 and the holding mechanism 1 from the inside of a shelf such that the holding mechanism 1 operates in a horizontal direction.

Although operation procedure is shown in a case where a space through which the object G1 can be pulled out exists above the object G2 in FIGS. 6A-6F, when a space through which the object G1 can be pulled out exists in a lateral direction of the object G2, the object G1 may be pulled out in the lateral direction.

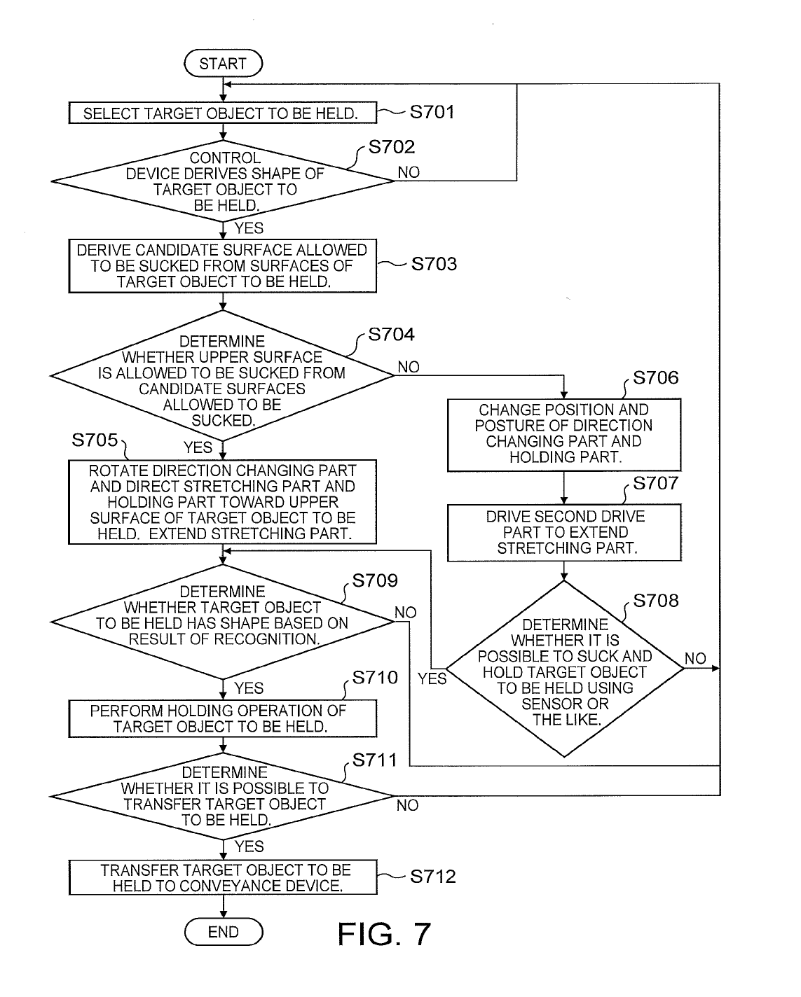

FIG. 7 is a flowchart showing an example of processing for transferring an object in the handling robot system according to the present embodiment.

First, the control device 120 selects a target object to be held, based on a result of recognition of the recognition device 130 and the recognition part 9 (step 701).

The control device 120 derives a shape of the target object to be held (step 702).

When it is impossible to derive a shape of the target object to be held (step 702, the case of No), another object is selected (returning to step 701).

When the shape of the target object to be held is derived (step 702, the case of Yes), the control device 120 derives a candidate surface allowed to be sucked from surfaces of the target object to be held (step 703).

The control device 120 determines whether an upper surface of the candidate surfaces allowed to be sucked is allowed to be sucked (step 704). When the upper surface of the target object to be held is allowed to be sucked (step 704, the case of Yes), the control device 120 rotates the direction changing part 4 in order to hold the target object to be held, and directs the stretching part 5 and the holding part 6 to the upper surface of the target object to be held. Then, the control device 120 drives the second drive part 7 to extend the stretching part 5 (step 705).

When the upper surface of the target object to be held is not allowed to be sucked (step 704, the case of No), the control device 120 changes the position posture of the direction changing part 4 and the holding part 6. For example, as shown in FIG. 6B, the posture of the holding part 6 is changed so as to hold the inclined portion of the target object to be held (step 706).

The control device 120 drives the second drive part 7 to extend the stretching part 5 (step 707).

The control device 120 determines whether the target object to be held has a shape based on a result of recognition (step 708).

When the target object to be held has an assumed shape (step 708, the case of Yes), the control device 120 determines whether it is possible to suck and hold the target object to be held. The determination is performed using a pressure sensor, a flow sensor, a contact sensor, a proximity sensor, etc., which are installed in the holding part (step 709). When the target object to be held does not have an assumed shape (step 708, the case of No), another target object to be held is selected (returning to step 701).

When it is determined that it is possible to hold the target object to be held (step 709, the case of Yes), the control device 120 performs an operation for holding the target object to be held (step 710). When it is determined that it is hard to hold the target object to be held (step 709, the case of No), the control device 120 selects another target object to be held (returning to step 701).

The transfer operation includes the contraction operation of the stretching part 5 or the operation of the direction changing part 4. The control device 120 determines whether it is possible to transfer the target object to be held (step 711).

When it is determined that it is hard to transfer the target object to be held (step 711, the case of No), the control device 120 selects another target object to be held (returning to step 701)

When it is determined that it is possible to transfer the target object to be held (step 711, the case of Yes), the control device 120 transfers the target object to be held to the conveyance device 140 (step 712).

Thereafter, the transfer processing is terminated. The control device 120 may repeatedly perform the above-described flow as many times as the number of target objects to be held.

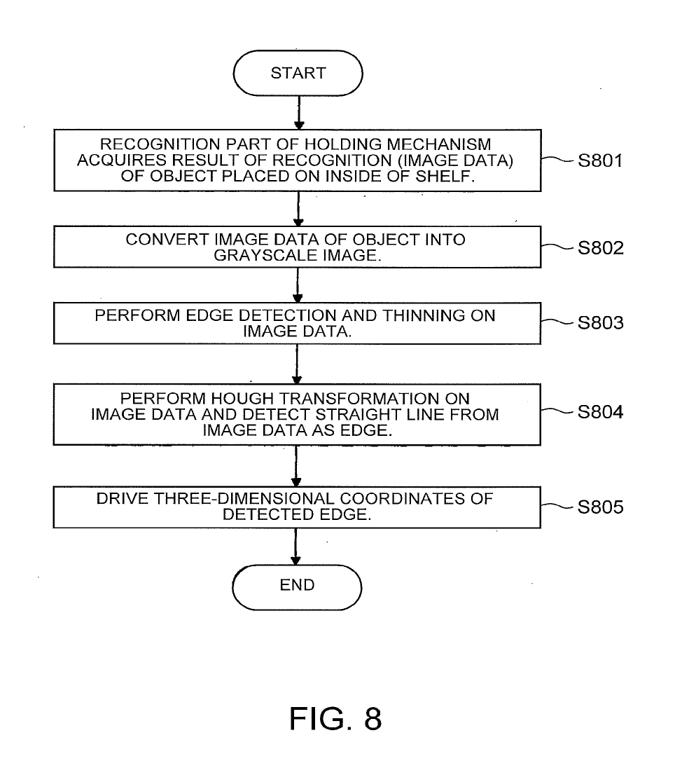

FIG. 8 is a flowchart showing an example of processing of the step 701 in FIG. 7.

First, the control device 120 acquires a result obtained by recognizing an object placed in the inside of the shelf by the recognition part 9 of the holding mechanism 1 (step 801). The result of recognition by the recognition part 9 is, for example, image data.

Next, the control device 120 converts the image data for the object into a greyscale image (step 802).

Subsequently, the control device 120 performs edge detection and thinning on the image data (step 803).

Subsequently, the control device 120 performs Hough transformation on the image data, and detects a straight line from the image data as an edge (step 804).

Thereafter, the control device 120 derives three-dimensional coordinates of the detected edge (step 805).

The control device 120 selects, as a target object to be held, an object having the same edge as edge information of a target to be transferred in advance in accordance with the transfer order. Alternatively, the control device 120 selects, as a target object to be held, an object having an edge that can be held by the holding mechanism 1. The transfer order may be indicated by an operator in advance. Also, the control device 120 may perform transferring from an object determined to be held and conveyed by the holding mechanism 1 without contacting other objects.

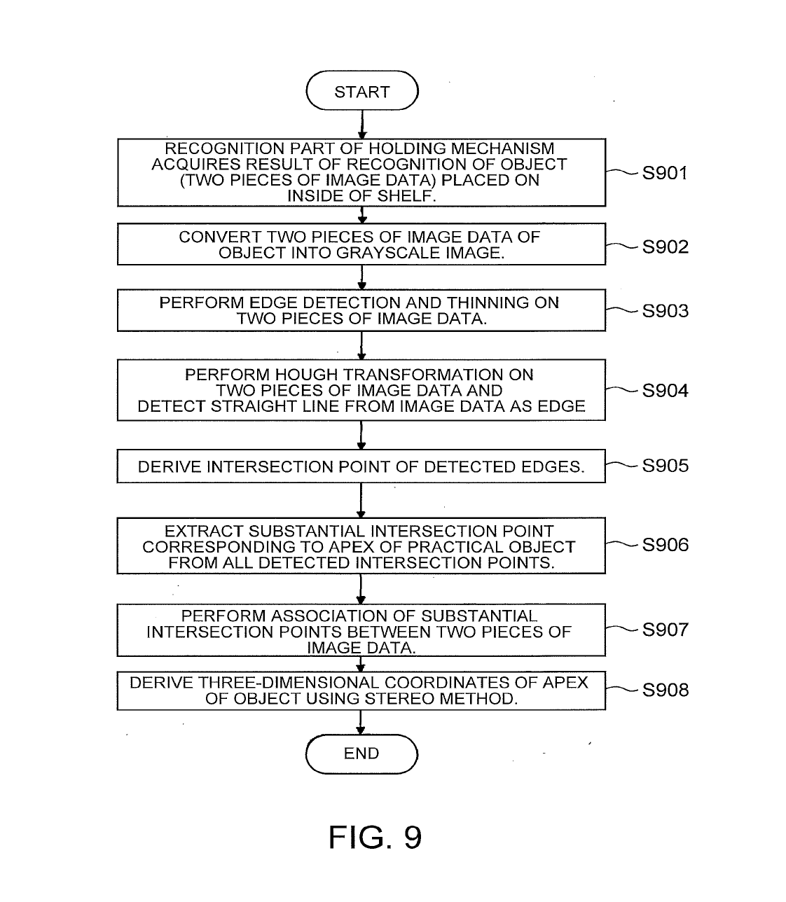

FIG. 9 is a flowchart showing an example of processing of step 702 in FIG. 7. Here, a three-dimensional position of an object is calculated based on at least two pieces of image data in which the recognition part 9 recognizes the object at different positions. The control device 120 performs processing of step 901 to step 908 in FIG. 9 with respect to each piece of image data. The processing from step 901 to step 904 shown in FIG. 9 is identical to that of step 801 to step 804 in FIG. 8, and therefore, the description thereof will be omitted.

The control device 120 derives an intersection point of detected edges (step 905).

The control device 120 extracts a substantial intersection point corresponding to an apex of a practical object from the all calculated intersection points (step 906).

The control device 120 performs association of substantial intersection points between the at least two pieces of image data. In this case, in order to perform more precise association, the association may be performed by using color information of the acquired image data (step 907).

The control device 120 derives three-dimensional coordinates of the apex of the object by using the stereo method (step 908).

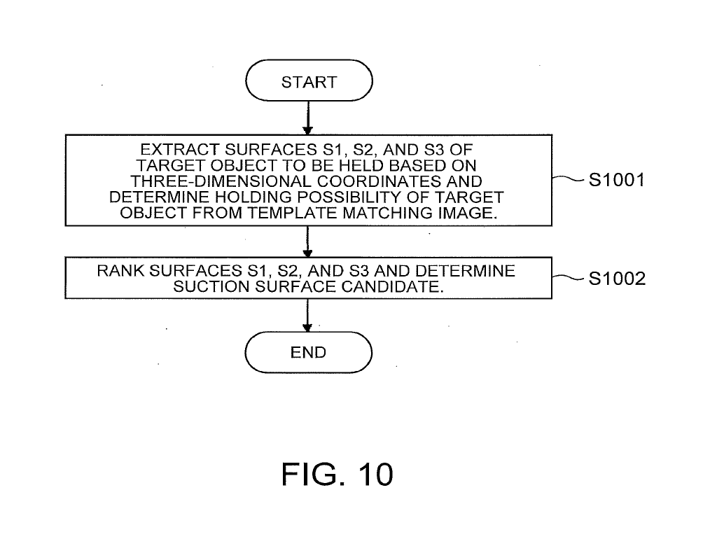

FIG. 10 is a flowchart showing an example of processing of the step 703 in FIG. 7. The control device 120 extracts surfaces of the target object to be held, based on the above-described three-dimensional coordinates of the apex. Here, the object is assumed to have a rectangular parallelepiped shape, the side surface of the object is defined as the surface S1, the upper surface of the object is defined as the surface S2, and the side surface that shares the edge with the surface S1 and the surface S2 is defined as S3.

The control device 120 determines holding possibility of the surfaces S1, S2, S3 of the target object from, for example, a template matching image (step 1001).

The control device 120 ranks the surfaces S1, S2 and S3, and determines suction surface candidates (step 1002). The object is not limited to a rectangular parallelepiped shape and may be a polyhedron. Further, deriving of the suction surface candidates may be performed based on more than the three surfaces S1 to S3.

Since the holding mechanism 1 according to the present embodiment has the stretching part 5, it is possible to hold even an object located outside the drive range of the manipulator 111 by extending the stretching part 5.

Further, since the holding mechanism 1 includes the direction changing part 4 that is rotated by the driving of the first drive part 3, it is possible to freely change the orientations of the stretching part 5 and the holding part 6. As a result, it is possible to change an extension direction of the stretching part 5 according to the position of the object G.

In addition, by using the second drive part 7 and the tube 8, the stretching operation can be realized with a simple configuration of moving the tube 8 by the second drive part 7 to stretch the stretching part 5.

In addition, even when the target object to be held located in the inside of the shelf is positioned behind another object, the holding mechanism 1 is elongated, and the position of the holding part 6 can be freely changed by the direction changing part 4 and the stretching part 5. Thus, objects can be held efficiently.

In addition, the holding mechanism 1 can recognize the position information of the object accurately by having the recognition part 9 even when the object to be held is positioned behind another object.

Further, since the stretching part 5 has a paper rolling shape, the stretching part 5 can be easily in the contracted state by an elastic force. In addition, since the thin metal plate is wound around a predetermined shaft, high rigidity can be ensured even in the extended state.

Further, in the handling robot system according to the present embodiment, it is possible to recognize the placing state of objects from various angles by the recognition device 130 and the recognition part 9 of the holding mechanism 1.

The handling robot system according to the present embodiment has the transfer device 110, the control device 120 and the recognition device 130. Furthermore, the handling robot system includes a picking device and an inspection device that independently moves to a shelf on which an object G is placed, and performs picking or inspection of the object G. In addition, the handling robot system according to the present embodiment includes a cargo bed in which the object G is received, and includes an object dispensing device and a loading device for delivering objects G from the cargo bed to a shelf or the like.

### Second Embodiment

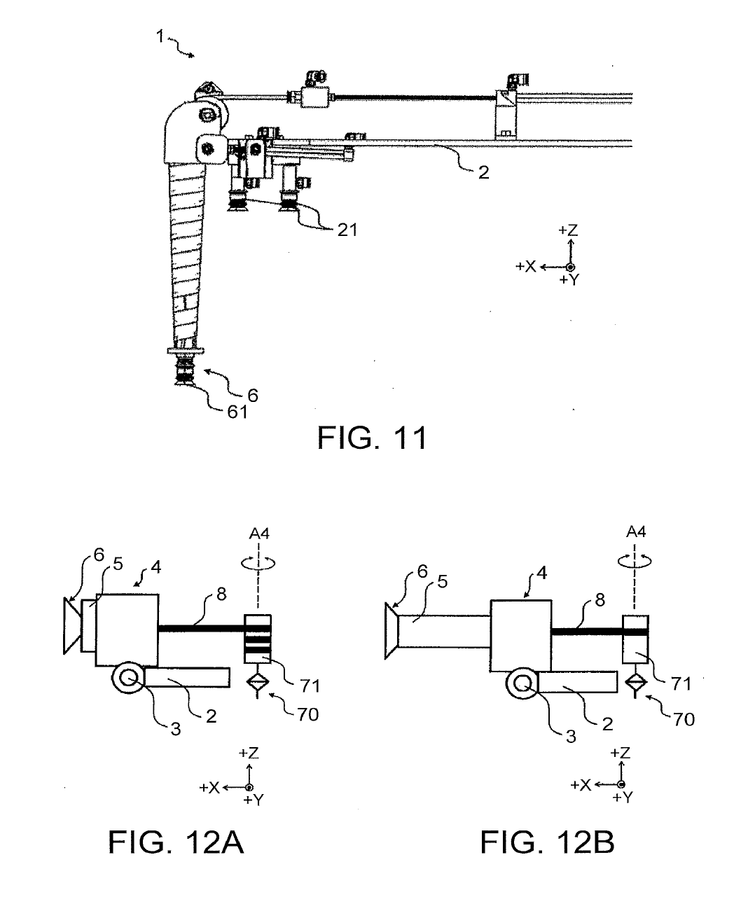

The second embodiment will be described with reference to FIG. 11. FIG. 11 is a diagram showing an example of a holding mechanism according to the second embodiment.

As shown in FIG. 11, in the holding mechanism according to the second embodiment, a suction part 21 is installed in the base part 2. Other configurations of the holding mechanism are identical to those of the holding mechanism according to the first embodiment.

The suction part 21 includes at least one suction pad, and is installed in the −Z direction with respect to the base part 2. The suction pad is connected to a vacuum pump or the like, and can suck by being depressurized between an object G and a vacuum pump, etc. When the stretching part 5 is in a contracted state and the holding part 6 is directed in the −Z direction (in a state where the direction changing part 4 is rotated by 90°), the suction part 21 is at the same height as the suction pad 61 of the holding part 6.

Since the holding mechanism 1 according to the present embodiment has the suction part 21, the object G can be held by a plurality of suction pads. Thus, the stability of holding can be improved.

Further, since the object G can also be held by the suction part 21, when the object G is moved by contracting the stretching part 5 after the stretching part 5 is extended and the object G is held by the holding part 6, stability of holding can be improved.

### Third Embodiment

The third embodiment will be described with reference to FIGS. 12A and 12B. FIGS. 12A and 12B are schematic views showing an example of a holding mechanism according to the third embodiment. FIG. 12A shows a contracted state of the holding mechanism. FIG. 12B shows an extended state of the holding mechanism.

As shown in FIGS. 12A and 12B, the holding mechanism according to the third embodiment includes a rotary drive part 70 instead of the second drive part 7. Other configurations of the holding mechanism are identical to those of the holding mechanism according to the first embodiment.

The rotary drive part 70 has a tube 8 wound around a shaft 71, and an end of the tube 8 is connected to the holding part 6. By driving the rotary drive part 70, a length of the tube 8 from the rotary drive part 70 to the holding part 6 can be changed freely. That is, the stretching part 5 operates to be stretched according to the length of the tube 8 from the rotary drive part 70 to the holding part 6. The rotary drive part 70 operates to be rotated around the rotary shaft A4 by a motor or the like.

The holding mechanism according to the present embodiment can reduce the mechanisms of the drive part and the base part 2 by using the rotary drive part 70 instead of the second drive part 7. Therefore, it is possible to reduce the size of the holding mechanism.

### Fourth Embodiment

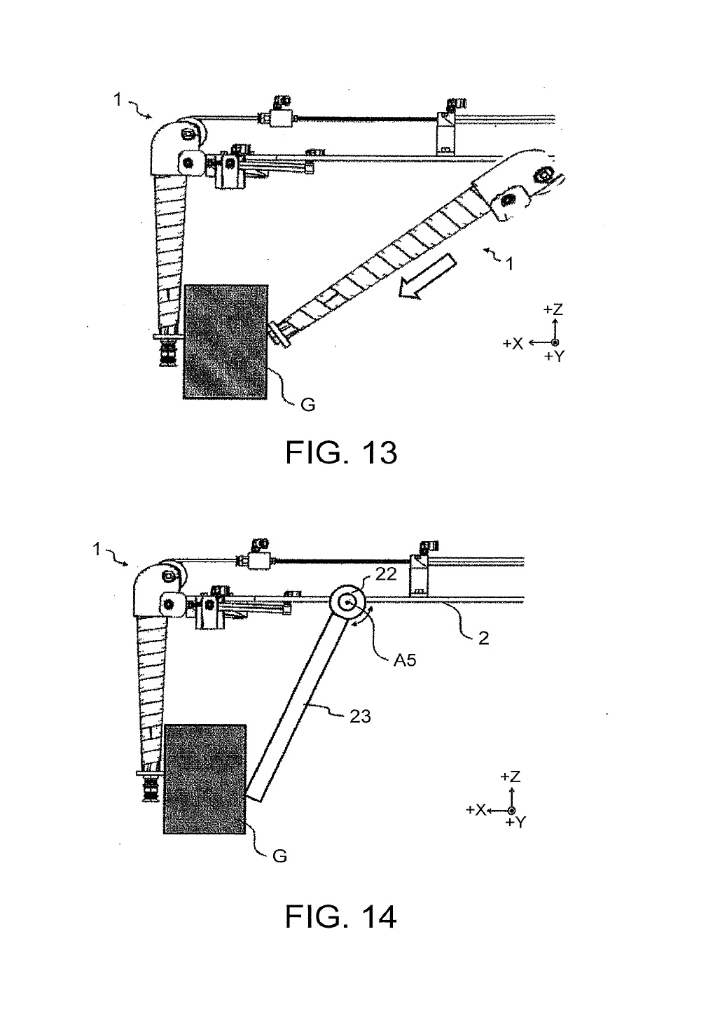

The fourth embodiment will be described with reference to FIG. 13. FIG. 13 is a diagram showing an example of a holding mechanism according to the fourth embodiment.

As shown in FIG. 13, the holding mechanism according to the fourth embodiment includes two holding mechanisms 1. Other configurations of the holding mechanism are identical to those of the holding mechanism according to the first embodiment.

As shown in FIG. 13, the two holding mechanisms may be arranged in parallel in the X direction such that the positions of holding parts are shifted from each other.

By including the two holding mechanisms 1, it is possible to clamp and hold the object G. In a case of using a suction pad for the holding part 6 of the holding mechanism, it was difficult to suck an object made of messy material having a large amount of air leakage or an object having a curved member having a large curvature. By clamping the object G using the holding mechanism according to the present embodiment, it is possible to handle objects of various shapes and increase the types of objects capable of being handled.

Also, by stretching two stretching parts 5, the lengths of the stretching parts can be changed freely. Therefore, freedom of clamping can be improved.

### Fifth Embodiment

The fifth embodiment will be described with reference to FIG. 14. FIG. 14 is a diagram showing an example of a holding mechanism according to the fifth embodiment.

As shown in FIG. 14, a holding mechanism according to the fifth embodiment includes a rotary drive part 22 installed in the base part 2 and a plate body 23 connected to the rotary drive part 22. Other configurations of the holding mechanism are identical to those of the holding mechanism according to the first embodiment. The rotary drive part 22 is driven to be rotated around the rotary shaft A5 to rotate the plate body. The plate body may be a metal plate having a rigidity enough to clamp an object G, for example. The shape of the plate body may be changed to be suitable for the shape of the object G to be held.

In the holding mechanism according to the present embodiment, it is possible to not only hold the object by suction using the holding part 6, but also hold the object G by clamping the object G using the stretching part 5 and the plate body 23.

By clamping the object G using the holding mechanism according to the fifth embodiment, it is possible to handle an object having a complicated shape which is not to be held by suction. Therefore, the types of handling objects can be increased.

### Sixth Embodiment

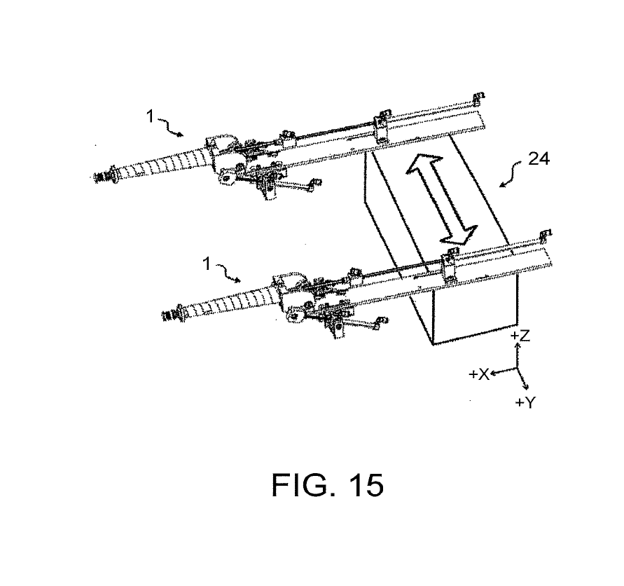

The sixth embodiment will be described with reference to FIG. 15. FIG. 15 is a diagram showing an example of a holding mechanism according to the sixth embodiment.

As shown in FIG. 15, the holding mechanism according to the sixth embodiment includes two holding mechanisms 1 and a base 24 capable of linearly moving the two holding mechanisms 1 in the Y direction respectively. Other configurations of the holding mechanism are identical to those of the holding mechanism according to the first embodiment.

By moving the two holding mechanisms 1, the base 24 is capable of holding the object G by each of the stretching parts 5. Also, in a case of sucking and holding the object G by the holding mechanism 1, the base 24 can adjust the holding position by moving the holding mechanism 1.

Since the holding mechanism according to the present embodiment is a parallel opening/closing type clamping mechanism, the holding mechanism is capable of holding an object G more stably.

Also, by stretching the stretching part of each of the holding mechanisms 1, it is possible to perform holding according to the placing environment of objects.

Also, since it is possible to use the two holding mechanisms even when holding is performed by suction, stability of the holding can be improved.

In addition, regardless of the suction pad, the above-described holding part according to the embodiment may be, for example, a gripper type holding part of pneumatic drive or a jamming type holding part. The jamming type holding part is a generic term for a holding device that limits liquidity of contents and solidifies them according to the shape of an object by filling the bag-like inside thereof with contents such as particles and vacuuming it. In addition, it may be a holding part of the electric driving mechanism, or a holding part configured to hold the object adhesively by applying an adhesive or the like. The embodiments are not limited to the suction pad as long as configuration is capable of holding an object.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A holding mechanism comprising:
a base part;
a first drive part connected to an end of the base part;
a direction changing part connected to the first drive part and rotatable by driving of the first drive part;
a stretching part that is stretchable and connected to the direction changing part at an end of the stretching part;
a holding part to hold an object, connected to the other end of the stretching part;
a second drive part able to be driven in a first direction; and
a tube connected to the holding part and the second drive part, and movable in the first direction by driving of the second drive part.

2. The holding mechanism according to claim 1,
wherein the tube is bendable according to rotation of the direction changing part.

3. The holding mechanism according to claim 1,
wherein the direction changing part includes a roller configured to bend the tube in a predetermined direction according to driving of the first drive part.

4. The holding mechanism according to claim 1,
wherein
the holding part is moved according to movement of the tube, and
the stretching part is stretched according to movement of the holding part.

5. The holding mechanism according to claim 1,
wherein
the stretching part is stretchable in the first direction, and
in a case where the direction changing part is rotated, the stretching part is stretchable in a second direction intersecting with the first direction.

6. The holding mechanism according to claim 1,
wherein the stretching part has a wound body formed by winding a plate around a shaft through which the tube passes.

7. The holding mechanism according to claim 6,
wherein
a winding start portion of the wound body is connected to the holding part, and
a winding end portion of the wound body is connected to the direction changing part.

8. The holding mechanism according to claim 1,
wherein the stretching part has a plurality of linear moving guides.

9. The holding mechanism according to claim 1,
wherein the holding part has a suction pad.

10. The holding mechanism according to claim 1, further comprising:
a pressure reduction device that reduces a pressure of air inside the holding part connected to the tube.

11. The holding mechanism according to claim 1, further comprising:
a recognition part that recognizes a position of the object.

12. A transfer device comprising:
the holding mechanism of claim 1; and
a manipulator that moves the holding mechanism.

13. A picking device comprising;
the transfer device of claim 12; and
a recognition part that recognizes the object.

14. A handling robot system comprising:
the transfer device of claim 12;
a recognition device that recognizes the object held by the transfer device; and
a control device that controls driving of the transfer device, based on a result of recognition by the recognition device.
